(19) United States
(12) Patent Application Publication
(10) Pub. No.: US 2013/0339831 A1
(43) Pub. Date: Dec. 19, 2013

(54) DYNAMIC REPORTS CONNECTED TO PROJECT DATA

(71) Applicants: Amruta Ajitkumar Gulanikar, Seattle, WA (US); Lingnan Becker, Redmond, WA (US); Adam Lee Welborn, Redmond, WA (US); Heather Joy O'Cull, Seattle, WA (US); Ryan Ayroso LaFontaine, Seattle, WA (US)

(72) Inventors: Amruta Ajitkumar Gulanikar, Seattle, WA (US); Lingnan Becker, Redmond, WA (US); Adam Lee Welborn, Redmond, WA (US); Heather Joy O'Cull, Seattle, WA (US); Ryan Ayroso LaFontaine, Seattle, WA (US)

(73) Assignee: MICROSOFT CORPORATION, Redmond, WA (US)

(21) Appl. No.: 13/525,247

(22) Filed: Jun. 15, 2012

(51) Int. Cl. G06F 17/00

(52) U.S. Cl. 715/210

(57) ABSTRACT

Project data is used to create dynamic reports that automatically update when the project data changes. The selected project data is used for the display of one or more graphical objects (e.g. charts, tables). A graphical user interface (GUI) may be used to select project data fields from the project data. The selected data fields are used to determine the project data to access that is then mapped to a format understood by the graphical object (e.g. project data storage format to a cross tabular format). The graphical object is configured to treat the selected project data as a data source. When the project data changes, the graphical object is automatically updated.

### BACKGROUND

Project management software is used by project managers to create and maintain their project schedules. Project plans typically contain a lot of data regarding tasks, resources, project costs, budget, and the like. One of the responsibilities of a Project Manager (PM) is to track and report a project's progress. Creating reports using the project data, however, can be cumbersome.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Project data is used to create dynamic reports that automatically update when the project data changes. The selected project data is used for the display of one or more graphical objects (e.g. charts, tables). A graphical user interface (GUI) may be used to select project data fields from the project data. The selected data fields are used to determine the project data to access that is then mapped to a format understood by the graphical object (e.g. project data storage format to a cross tabular format). The graphical object is configured to treat the selected project data as a data source. When the project data changes, the graphical object is automatically updated.

### BRIEF DESCRIPTION OF THE DRAWINGS

FIG. 1 illustrates an exemplary system for dynamic reports using project data;

FIG. 2 shows a system for dynamic reporting of project data;

FIGS. 3A and 3B shows an illustration of converting project data to a format understood by the graphical object;

FIG. 4 shows an illustrative process for dynamically creating reports using project data; and

FIGS. 5-7 and the associated descriptions provide a discussion of a variety of operating environments in which embodiments of the invention may be practiced.

### DETAILED DESCRIPTION

Referring now to the drawings, in which like numerals represent like elements, various embodiments will be described.

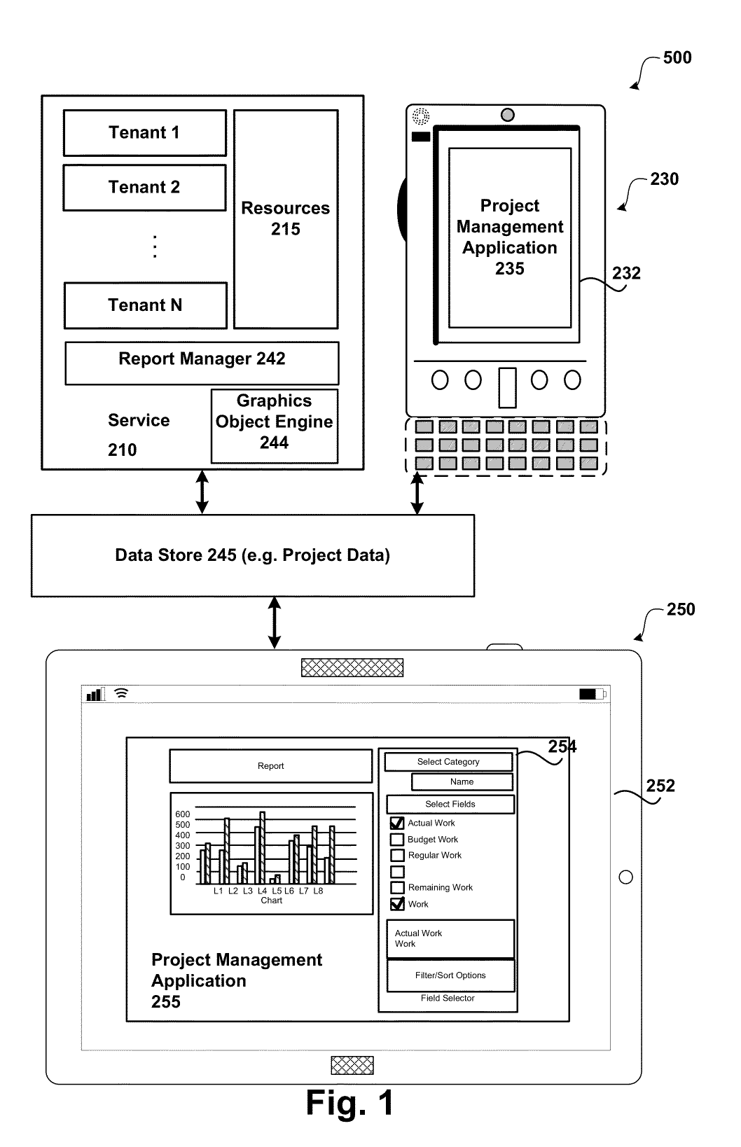

FIG. 1 illustrates an exemplary system for dynamic reports using project data. As illustrated, system 100 includes service 210, data store 245, touch screen input device/display 250 (e.g. a slate) and smart phone 230.

Generally, system 100 is used to create dynamic reports that are automatically updated when project data changes. Project data is used to create dynamic reports that automatically update when the project data changes. The selected project data is used for the display of one or more graphical objects (e.g. charts, tables). A graphical user interface (GUI) may be used to select project data fields from the project data. The selected data fields are used to determine the project data to access that is then mapped to a format understood by the graphical object (e.g. project data storage format to a cross tabular format). The graphical object is configured to treat the selected project data as a data source. When the project data changes, the graphical object is automatically updated.

As illustrated, service 210 is a cloud based and/or enterprise based service that may be configured to provide services, such as project management services (e.g. MICROSOFT PROJECT), productivity services (e.g. MICROSOFT OFFICE 365 or some other cloud based/online service that is used to interact with items (e.g. project data, messages, spreadsheets, documents, charts . . . ) and the like. The service may be interacted with using different types of input/output. For example, a user may use touch input, hardware based input, speech input, and the like. Functionality of one or more of the services/applications provided by service 210 may also be configured as a client/server based application. For example, a client device may include an application that performs project management operations that utilize project data. Although system 100 shows a service relating to project management applications, other services/applications may be configured.

As illustrated, service 210 is a multi-tenant service that provides resources 215 and services to any number of tenants (e.g. Tenants 1-N). Multi-tenant service 210 is a cloud based service that provides resources/services 215 to tenants subscribed to the service and maintains each tenant's data separately and protected from other tenant data.

System 100 as illustrated comprises a touch screen input device/display 250 (e.g. a slate/tablet device) and smart phone 230 that detects when a touch input has been received (e.g. a finger touching or nearly touching the touch screen). Any type of touch screen may be utilized that detects a user's touch input. For example, the touch screen may include one or more layers of capacitive material that detects the touch input. Other sensors may be used in addition to or in place of the capacitive material. For example, Infrared (IR) sensors may be used. According to an embodiment, the touch screen is configured to detect objects that in contact with or above a touchable surface. Although the term “above” is used in this description, it should be understood that the orientation of the touch panel system is irrelevant. The term “above” is intended to be applicable to all such orientations. The touch screen may be configured to determine locations of where touch input is received (e.g. a starting point, intermediate points and an ending point). Actual contact between the touchable surface and the object may be detected by any suitable means, including, for example, by a vibration sensor or microphone coupled to the touch panel. A non-exhaustive list of examples for sensors to detect contact includes pressure-based mechanisms, micro-machined accelerometers, piezoelectric devices, capacitive sensors, resistive sensors, inductive sensors, laser vibrometers, and LED vibrometers.

According to an embodiment, smart phone 230 and touch screen input device/display 250 are configured to receive text/speech input and output text/speech. Smart phone 230 and touch screen input device/display 250 also include project management applications (e.g. applications 235 and 255) related to project management.

As illustrated, touch screen input device/display 250 and smart phone 230 shows exemplary displays 252/232. Display 253 shows the use of application 255 using project management data (254). For example, a user associated with slate device 250 may be using application 254 to view project data relating to one or more projects. A user associated with smartphone 230 may be interacting with application 235 that provides functionality relating to project data. Many other types of applications may utilize project data. For example, a presentation application may include a view of project data within the presentation, a spreadsheet may include project data and the like. Data, including project data, may be stored on a device (e.g. smart phone 230, slate 250 and/or at some other location (e.g. network data store 245). The applications 235, 255 may be a client based application, a server based application, a cloud based application and/or some combination.

Report manager 242 is configured to perform operations relating to creating dynamic reports using project data. While manager 242 is shown within service 210, the functionality of the manager may be included in other locations (e.g. on smart phone 230 and/or slate device 250).

Graphics objects engine 244 is configured to display graphic objects from data that is provided in a known format. According to an embodiment, the engine 244 is used by different applications using a standard application programming interface (API). For example, a spreadsheet application, presentation application and the like may use engine 244 to render different graphical objects. The graphic objects may be many different types of objects. According to an embodiment, engine 244 is the MICROSOFT OFFICE ART GRAPHIC ENGINE that supports Escher 2 objects such as charts, tables, shapes and pictures. For example, the graphic objects displayed using project data may be one or more of: following: Column charts; Bar charts; Line charts; Pie charts; XY (Scatter) charts; Area charts; Doughnut charts; Radar charts; Surface charts; Bubble charts; Stock charts; Cylinder, Cone, or Pyramid charts; XY (Scatter) and Line charts; Pie of Pie and Bar of Pie charts; Bubble charts; Surface charts; Histograms; Gantt charts and the like.

A user may select the project fields to include in the graphic object. For example, the user can insert a chart or table in a report and specify the project data to be modeled. For example, a graphical user interface 254 such as shown in display 252 may be used to select the project data fields to be displayed (e.g. the illustrated chart).

Once the user selects the project fields, the data from the selected fields are mapped to the type of graphic object to be displayed using report manager 242. According to an embodiment, the project data is mapped from the project data format to a crosstab format. According to an embodiment, a rowset from the project data is identified to map to the format supported by the graphical object. Other mappings may be performed depending on the type of project data and/or type of graphic object to be displayed. The graphic object(s) expects the data to be represented in a particular forma. In the current example, the project data is stored in database like structures that does not follow the format used by the graphic object. As such, an intermediate layer is created that transforms the identified rowset to a cross tabular format where each row represents a category to be plotted and each column represents a category labels/legend entries. This cross tabular format is transformed to the format expected by the graphical object (e.g. chart). As discussed, the project data are mapped to the data source for the graphical object.

A notification receiver is bound to the graphic object such that the selected project data acts as a data source for the graphic object. When the graphic object is bound to the notification receiver, the chart data is automatically updated when project data changes.

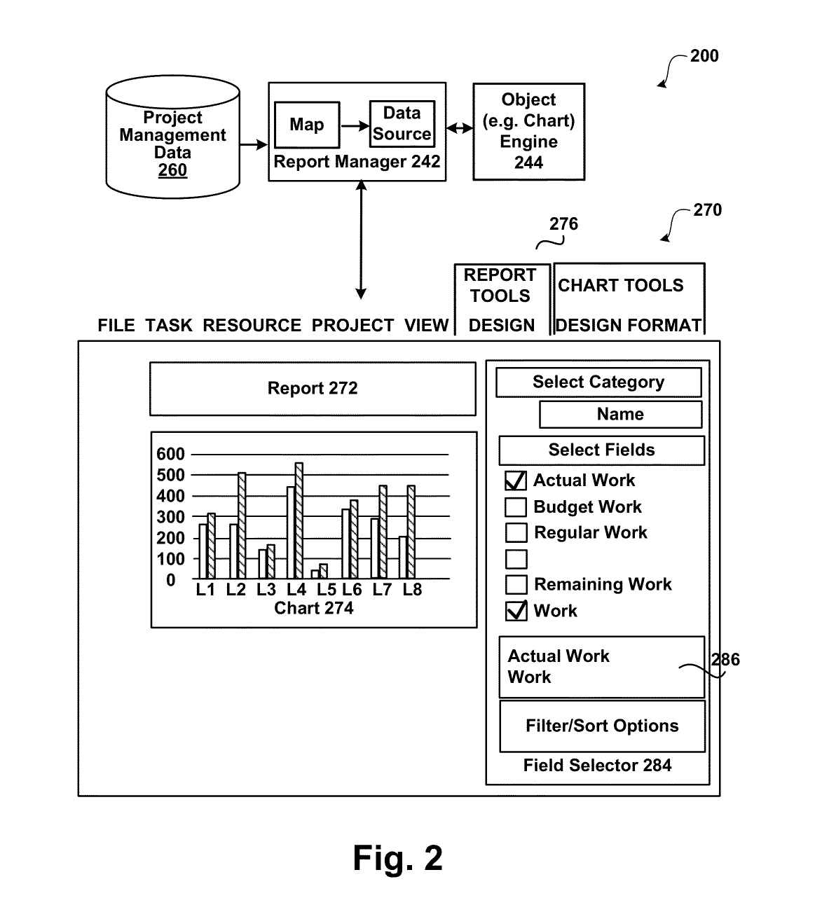

FIG. 2 shows a system for dynamic reporting of project data.

As illustrated, system 200 comprises project management data 260, report manager 242, object engine 244, and a display 270 that comprises a report 272, chart 274, report options 280, and graphical user interface comprising toolbar 276 and field selector 284.

In the current illustration, a task pane (Field Selector 284) is associated with the chart 274 that allows a user to specify the project data fields and elements to associate with the chart. In the example shown, the user has selected the fields Actual Work and Work that is shown in display area 286 and are shown as selected within the select fields are of the GUI. Options are also displayed that allow the user to navigate the project data (e.g. filter/sort options, category, name and fields options. A toolbar 276 shows various options that are associated with the project (e.g. file, task, resource, project, view, reporting tools, charting tools . . . ). Once the user has selected the project data to include in a graphical object(s), the graphical object is displayed and is automatically updated when the project data changes.

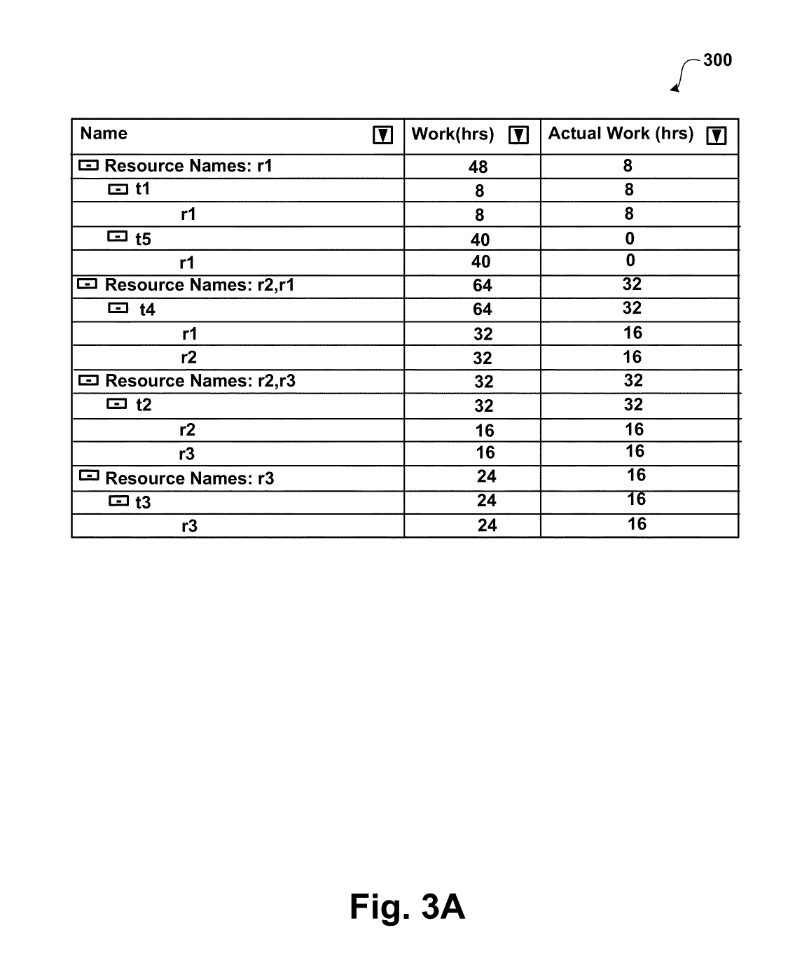

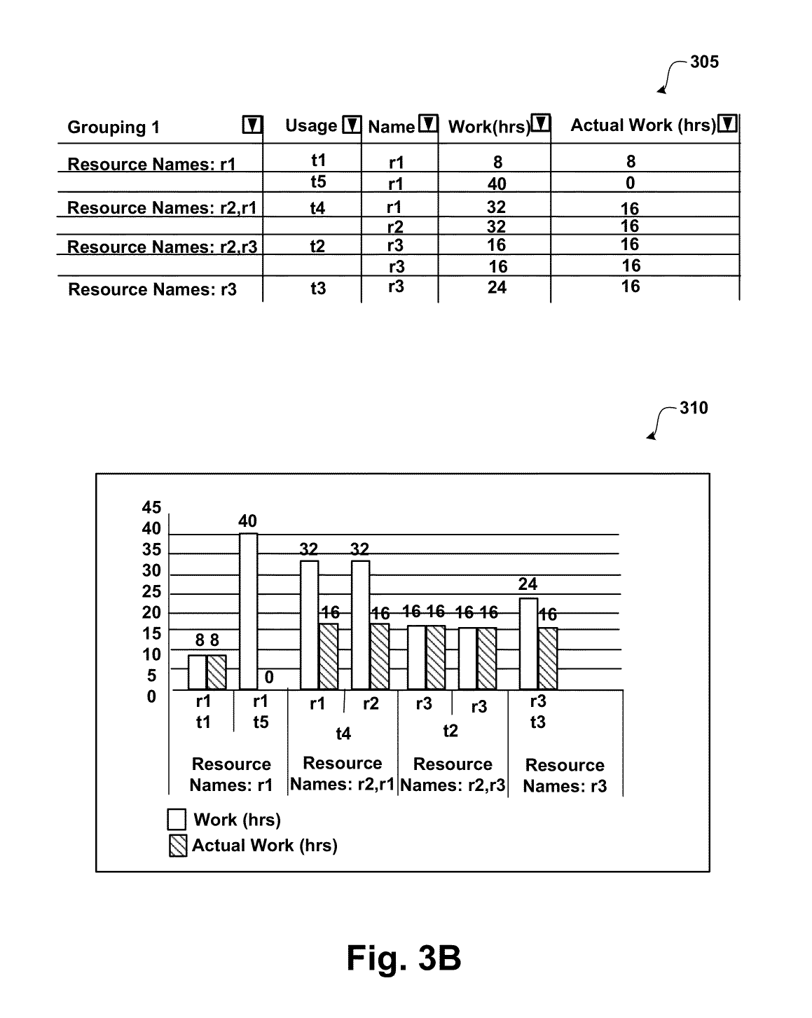

FIGS. 3A and 3B shows an illustration of converting project data to a format understood by the graphical object.

The following table illustrates project data that is displayed in a first format that is arranged by project and tasks.

| Task | | | | | Resource | |
|---|---|---|---|---|---|---|
| Name | Duration | Start | Finish | Predecessors | Names | % Complete |
| Project 1 | 15 days | 27 Sep.12 | 15 Oct. | | | 0% |
| t1 | 1 day | 27 Sep.12 | 27 Sep.12 | | r1 | 100% |
| t2 | 2 days | 28 Sep.12 | 29 Sep.12 | 1 | r2, r3 | 100% |
| t3 | 3 days | 30 Sep.12 | 04 Oct.12 | 2 | r3 | 67% |
| t4 | 4 days | 05 Oct.12 | 08 Oct.12 | 3 | r2, r1 | 50% |
| t5 | 6 days | 11 Sep.12 | 15 Oct.12 | 4 | r1 | 0% |

Display 300 of FIG. 3A shows a task usage view that is grouped by resource and the columns work and actual work are selected.

Display 305 of FIG. 3B shows the project data displayed in display 300 converted to a cross tabular format that is understandable by the chart object that has been selected to display the project data.

Display 310 of FIG. 3B shows the chart created using the project data illustrated in display 305. The Grouping 1 column, the usage column, and the name column in display serve as category labels in chart 310. The labels for the Work column and the Actual Work column serve as the series names and the data in the Work column and the Actual work column illustrated in display 305 are the data values in chart 310.

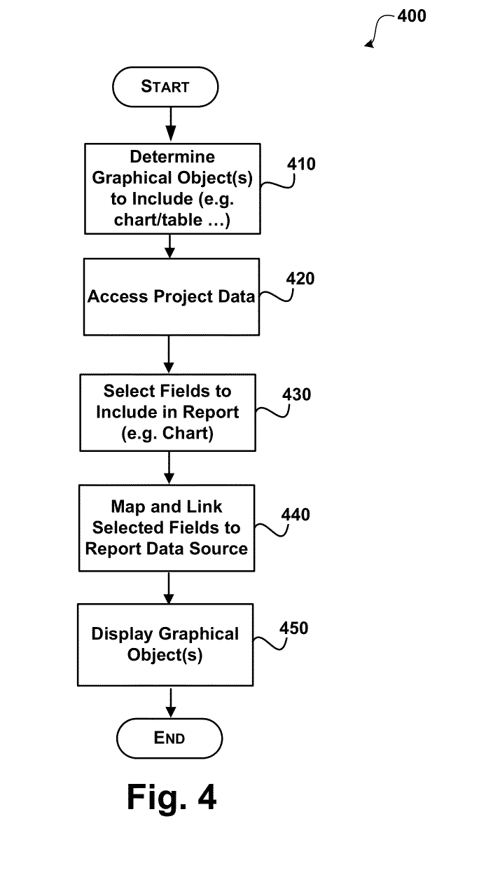

FIG. 4 shows an illustrative process for dynamically creating reports using project data. When reading the discussion of the routines presented herein, it should be appreciated that the logical operations of various embodiments are implemented (1) as a sequence of computer implemented acts or program modules running on a computing system and/or (2) as interconnected machine logic circuits or circuit modules within the computing system. The implementation is a matter of choice dependent on the performance requirements of the computing system implementing the invention. Accordingly, the logical operations illustrated and making up the embodiments described herein are referred to variously as operations, structural devices, acts or modules. These operations, structural devices, acts and modules may be implemented in software, in firmware, in special purpose digital logic, and any combination thereof.

After a start operation, process 400 flows to operation 410, where the graphical object(s) to display is selected. The graphical object(s) to display may be many types of different objects, such as charts, graphs, tables, and the like.

Transitioning to operation 420, project data is accessed. According to an embodiment, the project data is data that is associated with a project management application such as MICROSOFT PROJECT.

Moving to operation 430, fields from the project management data are selected to be included in a display of one or more graphical objects. For example, a user may use a Graphical User Interface (GUI) to select the fields to be included within the display of the graphical object (e.g. a chart, table, . . . ). The fields may include many different fields related to project management such as task, resource, and assignment fields. The task fields and task-timephased fields show task-related information and may show information for each task as distributed over its duration. The resource fields show information for each resource, including summarized information about tasks assigned to each resource. Resource-timephased fields show information for each resource as distributed over the duration of resource availability on the project. Assignment fields show information for each assignment. Assignment-timephased fields show information for each assignment as distributed over its duration. For exemplary project data fields see the project fields supported by MICROSOFT PROJECT. The selections may be stored for later use. For example, the selections may be used by a different project to display the selected fields.

Flowing to operation 440, the selected fields are mapped and linked to the graphic object that utilizes the selected project fields for display. According to an embodiment, the rowset(s) from the project data are identified from the selected project fields that are then mapped to a cross tabular format such that the graphical object using the project data correctly displays the project data. Generally, the selected fields are mapped from one format to another format that is supported by the graphical object. A notification receiver is also bound to the graphic object such that when the project data acting as the data source for the graphic object changes, the graphic object is automatically updated.

Transitioning to operation 450, the graphical object(s) is/are displayed using the selected fields from the project data. The process then moves to an end block and returns to processing other actions.

The embodiments and functionalities described herein may operate via a multitude of computing systems, including wired and wireless computing systems, mobile computing systems (e.g., mobile telephones, tablet or slate type computers, laptop computers, etc.). In addition, the embodiments and functionalities described herein may operate over distributed systems, where application functionality, memory, data storage and retrieval and various processing functions may be operated remotely from each other over a distributed computing network, such as the Internet or an intranet. User interfaces and information of various types may be displayed via on-board computing device displays or via remote display units associated with one or more computing devices. For example user interfaces and information of various types may be displayed and interacted with on a wall surface onto which user interfaces and information of various types are projected. Interaction with the multitude of computing systems with which embodiments of the invention may be practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

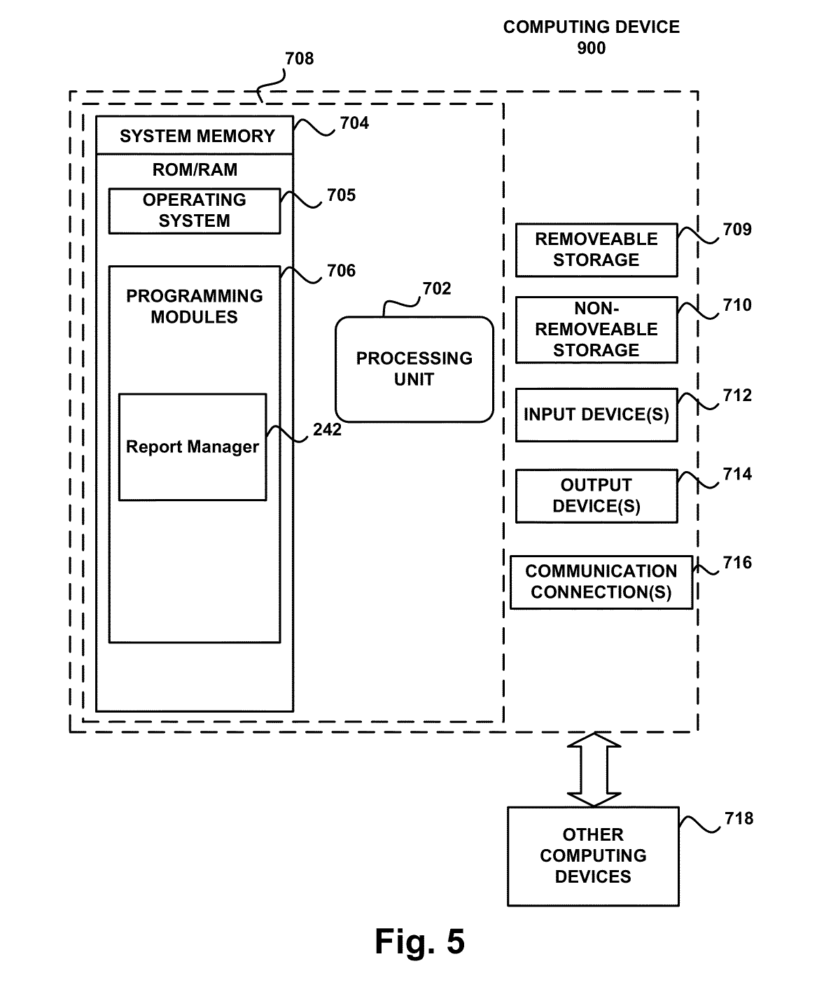

FIGS. 5-7 and the associated descriptions provide a discussion of a variety of operating environments in which embodiments of the invention may be practiced. However, the devices and systems illustrated and discussed with respect to FIGS. 5-7 are for purposes of example and illustration and are not limiting of a vast number of computing device configurations that may be utilized for practicing embodiments of the invention, described herein.

FIG. 5 is a block diagram illustrating example physical components of a computing device 900 with which embodiments of the invention may be practiced. The computing device components described below may be suitable for the computing devices described above. In a basic configuration, computing device 900 may include at least one processing unit 702 and a system memory 704. Depending on the configuration and type of computing device, system memory 704 may comprise, but is not limited to, volatile (e.g. random access memory (RAM)), non-volatile (e.g. read-only memory (ROM)), flash memory, or any combination. System memory 704 may include operating system 705, one or more programming modules 706, and may include a web browser application 720. Operating system 705, for example, may be suitable for controlling computing device 900's operation. In one embodiment, programming modules 706 may include a report manager 242, as described above, installed on computing device 900. Furthermore, embodiments of the invention may be practiced in conjunction with a graphics library, other operating systems, or any other application program and is not limited to any particular application or system. This basic configuration is illustrated in FIG. 5 by those components within a dashed line 708.

Computing device 900 may have additional features or functionality. For example, computing device 900 may also include additional data storage devices (removable and/or non-removable) such as, for example, magnetic disks, optical disks, or tape. Such additional storage is illustrated in FIG. 5 by a removable storage 709 and a non-removable storage 710.

As stated above, a number of program modules and data files may be stored in system memory 704, including operating system 705. While executing on processing unit 702, programming modules 706, such as the manager may perform processes including, for example, method 400 as described above. The aforementioned process is an example, and processing unit 702 may perform other processes. Other programming modules that may be used in accordance with embodiments of the present invention may include project management applications, electronic mail and contacts applications, word processing applications, spreadsheet applications, database applications, slide presentation applications, drawing or computer-aided application programs, etc.

Generally, consistent with embodiments of the invention, program modules may include routines, programs, components, data structures, and other types of structures that may perform particular tasks or that may implement particular abstract data types. Moreover, embodiments of the invention may be practiced with other computer system configurations, including hand-held devices, multiprocessor systems, microprocessor-based or programmable consumer electronics, minicomputers, mainframe computers, and the like. Embodiments of the invention may also be practiced in distributed computing environments where tasks are performed by remote processing devices that are linked through a communications network. In a distributed computing environment, program modules may be located in both local and remote memory storage devices.

Furthermore, embodiments of the invention may be practiced in an electrical circuit comprising discrete electronic elements, packaged or integrated electronic chips containing logic gates, a circuit utilizing a microprocessor, or on a single chip containing electronic elements or microprocessors. For example, embodiments of the invention may be practiced via a system-on-a-chip (SOC) where each or many of the components illustrated in FIG. 5 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to the manager 242 may be operated via application-specific logic integrated with other components of the computing device/system 900 on the single integrated circuit (chip). Embodiments of the invention may also be practiced using other technologies capable of performing logical operations such as, for example, AND, OR, and NOT, including but not limited to mechanical, optical, fluidic, and quantum technologies. In addition, embodiments of the invention may be practiced within a general purpose computer or in any other circuits or systems.

Embodiments of the invention, for example, may be implemented as a computer process (method), a computing system, or as an article of manufacture, such as a computer program product or computer readable media. The computer program product may be a computer storage media readable by a computer system and encoding a computer program of instructions for executing a computer process.

The term computer readable media as used herein may include computer storage media. Computer storage media may include volatile and nonvolatile, removable and non-removable media implemented in any method or technology for storage of information, such as computer readable instructions, data structures, program modules, or other data. System memory 704, removable storage 709, and non-removable storage 710 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 900. Any such computer storage media may be part of device 900. Computing device 900 may also have input device(s) 712 such as a keyboard, a mouse, a pen, a sound input device, a touch input device, etc. Output device(s) 714 such as a display, speakers, a printer, etc. may also be included. The aforementioned devices are examples and others may be used.

A camera and/or some other sensing device may be operative to record one or more users and capture motions and/or gestures made by users of a computing device. Sensing device may be further operative to capture spoken words, such as by a microphone and/or capture other inputs from a user such as by a keyboard and/or mouse (not pictured). The sensing device may comprise any motion detection device capable of detecting the movement of a user. For example, a camera may comprise a MICROSOFT KINECT® motion capture device comprising a plurality of cameras and a plurality of microphones.

The term computer readable media as used herein may also include communication media. Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

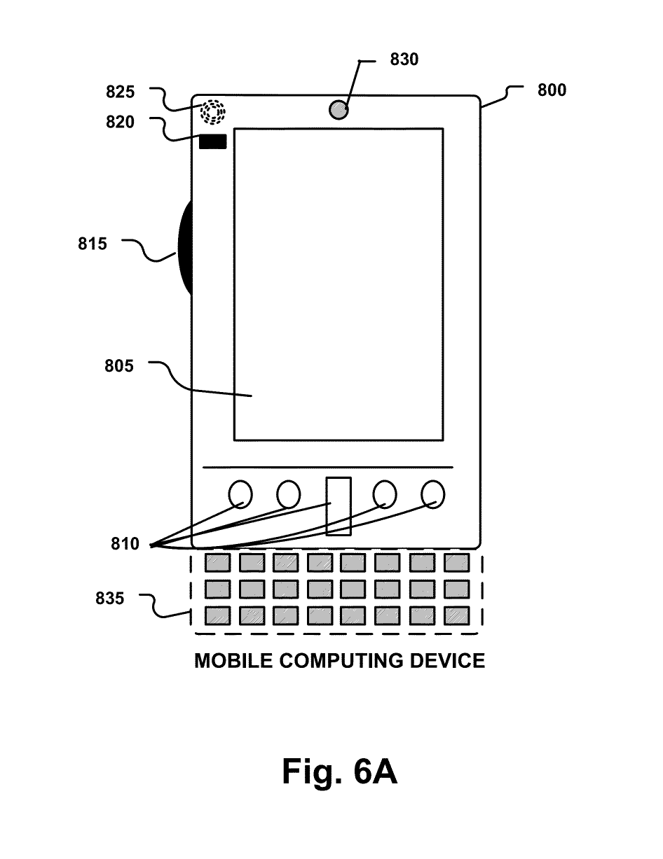

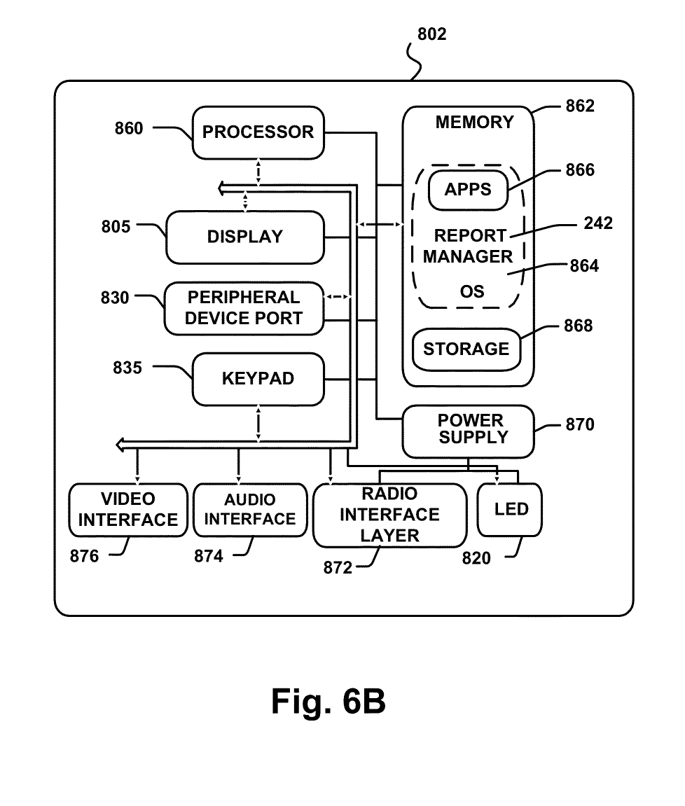

FIGS. 6A and 6B illustrate a suitable mobile computing environment, for example, a mobile telephone, a smartphone, a tablet personal computer, a laptop computer, and the like, with which embodiments of the invention may be practiced. With reference to FIG. 6A, an example mobile computing device 800 for implementing the embodiments is illustrated. In a basic configuration, mobile computing device 800 is a handheld computer having both input elements and output elements. Input elements may include touch screen display 805 and input buttons 815 that allow the user to enter information into mobile computing device 800. Mobile computing device 800 may also incorporate an optional side input element 815 allowing further user input. Optional side input element 815 may be a rotary switch, a button, or any other type of manual input element. In alternative embodiments, mobile computing device 800 may incorporate more or less input elements. For example, display 805 may not be a touch screen in some embodiments. In yet another alternative embodiment, the mobile computing device is a portable phone system, such as a cellular phone having display 805 and input buttons 815. Mobile computing device 800 may also include an optional keypad 835. Optional keypad 815 may be a physical keypad or a “soft” keypad generated on the touch screen display.

Mobile computing device 800 incorporates output elements, such as display 805, which can display a graphical user interface (GUI). Other output elements include speaker 825 and LED light 820. Additionally, mobile computing device 800 may incorporate a vibration module (not shown), which causes mobile computing device 800 to vibrate to notify the user of an event. In yet another embodiment, mobile computing device 800 may incorporate a headphone jack (not shown) for providing another means of providing output signals.

Although described herein in combination with mobile computing device 800, in alternative embodiments the invention is used in combination with any number of computer systems, such as in desktop environments, laptop or notebook computer systems, multiprocessor systems, micro-processor based or programmable consumer electronics, network PCs, mini computers, main frame computers and the like. Embodiments of the invention may also be practiced in distributed computing environments where tasks are performed by remote processing devices that are linked through a communications network in a distributed computing environment; programs may be located in both local and remote memory storage devices. To summarize, any computer system having a plurality of environment sensors, a plurality of output elements to provide notifications to a user and a plurality of notification event types may incorporate embodiments of the present invention.

FIG. 6B is a block diagram illustrating components of a mobile computing device used in one embodiment, such as the computing device shown in FIG. 6A. That is, mobile computing device 800 can incorporate system 802 to implement some embodiments. For example, system 802 can be used in implementing a “smart phone” that can run one or more applications similar to those of a desktop or notebook computer such as, for example, browser, e-mail, scheduling, instant messaging, and media player applications. In some embodiments, system 802 is integrated as a computing device, such as an integrated personal digital assistant (PDA) and wireless phoneme.

One or more application programs 866 may be loaded into memory 862 and run on or in association with operating system 864. Examples of application programs include phoneme dialer programs, e-mail programs, PIM (personal information management) programs, word processing programs, spreadsheet programs, Internet browser programs, messaging programs, and so forth. System 802 also includes non-volatile storage 868 within memory 862. Non-volatile storage 868 may be used to store persistent information that should not be lost if system 802 is powered down. Applications 866 may use and store information in non-volatile storage 868, such as e-mail or other messages used by an e-mail application, and the like. A synchronization application (not shown) may also reside on system 802 and is programmed to interact with a corresponding synchronization application resident on a host computer to keep the information stored in non-volatile storage 868 synchronized with corresponding information stored at the host computer. As should be appreciated, other applications may be loaded into memory 862 and run on the device 800, including the report manager 242, described above.

System 802 has a power supply 870, which may be implemented as one or more batteries. Power supply 870 might further include an external power source, such as an AC adapter or a powered docking cradle that supplements or recharges the batteries.

System 802 may also include a radio 872 that performs the function of transmitting and receiving radio frequency communications. Radio 872 facilitates wireless connectivity between system 802 and the “outside world”, via a communications carrier or service provider. Transmissions to and from radio 872 are conducted under control of OS 864. In other words, communications received by radio 872 may be disseminated to application programs 866 via OS 864, and vice versa.

Radio 872 allows system 802 to communicate with other computing devices, such as over a network. Radio 872 is one example of communication media. Communication media may typically be embodied by computer readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer readable media as used herein includes both storage media and communication media.

This embodiment of system 802 is shown with two types of notification output devices; LED 820 that can be used to provide visual notifications and an audio interface 874 that can be used with speaker 825 to provide audio notifications. These devices may be directly coupled to power supply 870 so that when activated, they remain on for a duration dictated by the notification mechanism even though processor 860 and other components might shut down for conserving battery power. LED 820 may be programmed to remain on indefinitely until the user takes action to indicate the powered-on status of the device. Audio interface 874 is used to provide audible signals to and receive audible signals from the user. For example, in addition to being coupled to speaker 825, audio interface 874 may also be coupled to a microphone 820 to receive audible input, such as to facilitate a telephone conversation. In accordance with embodiments of the present invention, the microphone 820 may also serve as an audio sensor to facilitate control of notifications, as will be described below. System 802 may further include video interface 876 that enables an operation of on-board camera 830 to record still images, video stream, and the like.

A mobile computing device implementing system 802 may have additional features or functionality. For example, the device may also include additional data storage devices (removable and/or non-removable) such as, magnetic disks, optical disks, or tape. Such additional storage is illustrated in FIG. 6B by storage 868. Computer storage media may include volatile and nonvolatile, removable and non-removable media implemented in any method or technology for storage of information, such as computer readable instructions, data structures, program modules, or other data.

Data/information generated or captured by the device 800 and stored via the system 802 may be stored locally on the device 800, as described above, or the data may be stored on any number of storage media that may be accessed by the device via the radio 872 or via a wired connection between the device 800 and a separate computing device associated with the device 800, for example, a server computer in a distributed computing network such as the Internet. As should be appreciated such data/information may be accessed via the device 800 via the radio 872 or via a distributed computing network. Similarly, such data/information may be readily transferred between computing devices for storage and use according to well-known data/information transfer and storage means, including electronic mail and collaborative data/information sharing systems.

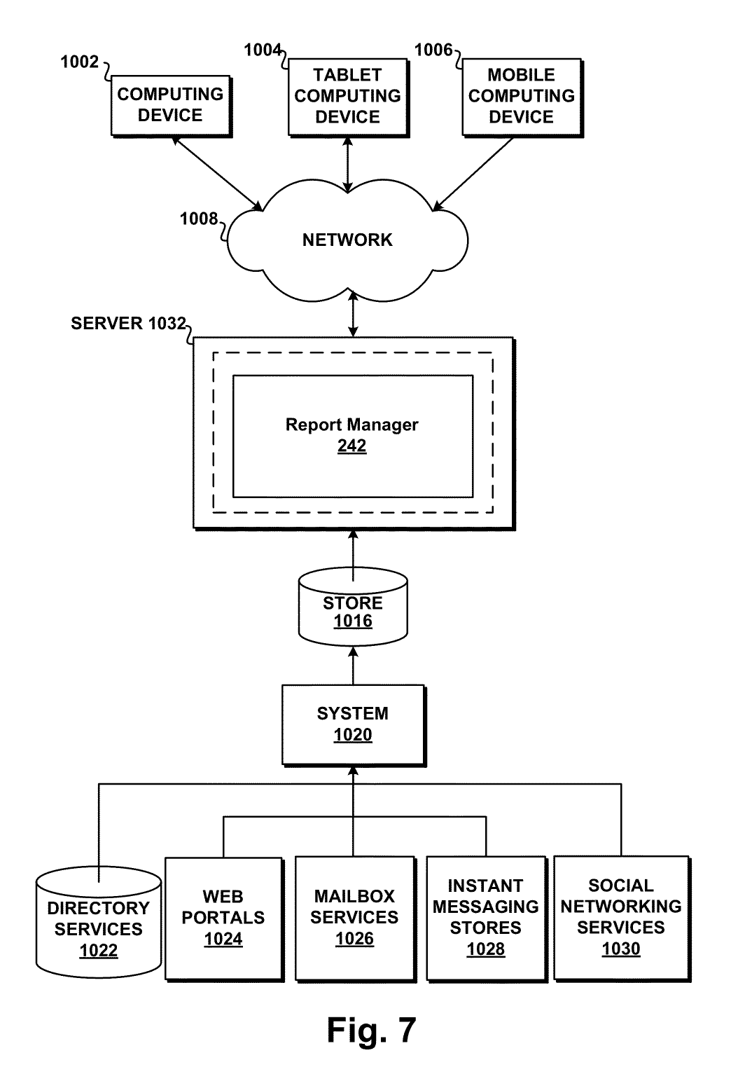

FIG. 7 illustrates a system architecture for creating and displaying dynamic reports for project data, as described above.

Components managed via the report manager 242 may be stored in different communication channels or other storage types. For example, components along with information from which they are developed may be stored using directory services 1022, web portals 1024, mailbox services 1026, instant messaging stores 1028 and social networking sites 1030. The systems/applications 242, 1020 may use any of these types of systems or the like for enabling management and storage of components in a store 1016. A server 1032 may provide communications for managed components and content to clients. As one example, server 1032 may provide project management related services. Server 1032 may provide services and content over the web to clients through a network 1008. Examples of clients that may utilize server 1032 include computing device 1002, which may include any general purpose personal computer, a tablet computing device 1004 and/or mobile computing device 1006 which may include smart phones. Any of these devices may obtain display component management communications and content from the store 1016.

Embodiments of the present invention are described above with reference to block diagrams and/or operational illustrations of methods, systems, and computer program products according to embodiments of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The above specification, examples and data provide a complete description of the manufacture and use of the composition of the invention. Since many embodiments of the invention can be made without departing from the spirit and scope of the invention, the invention resides in the claims hereinafter appended.

What is claimed is:

1. A method for creating a dynamic report using project data, comprising:
determining a graphical object to display using project data;
accessing the project data that is stored according to a first format comprising task fields, resource fields and assignment fields;
mapping selected fields from the project data from the first format to a second format that is used by a graphical object when displaying the project data;
linking the selected fields to the graphical object such that when values in the selected fields change a display of the graphical object changes; and
displaying the graphical object.

2. The method of claim 1, further comprising displaying a Graphical User Interface (GUI) to select the fields from the project data.

3. The method of claim 1, wherein linking the selected fields to the graphical object comprises treating the selected fields as a data source for the graphical object.

4. The method of claim 1, wherein mapping the selected fields from the project data from the first format to the second format comprises mapping the project data to a cross tabular format.

5. The method of claim 1, wherein displaying the graphical object comprises displaying the graphical object using a graphics object engine that displays graphic objects for different applications.

6. The method of claim 1, wherein the graphical object is selected from one of: a chart and a table.

7. The method of claim 6, wherein the GUI displays the selected fields from the project data for review.

8. The method of claim 7, wherein the GUI comprises filtering options and sorting options that act on the project data.

9. The method of claim 1, further comprising storing a definition of the selections such that the definition is usable within a different project.

10. A computer-readable medium having computer-executable instructions for creating a dynamic report using project data, comprising:
determining a graphical object to display using project data;
accessing the project data using a project management application that is stored according to a first format comprising task fields, resource fields and assignment fields;
mapping selected fields from the project data from the first format to a second format that is used by a graphical object when displaying the project data;
using the selected fields as a data source for the graphical object such that when values in the selected fields change a display of the graphical object changes; and
displaying the graphical object using a graphics object engine that supports the project management application and different applications.

11. The computer-readable medium of claim 10, further comprising displaying a Graphical User Interface (GUI) to select the fields from the project data.

12. The computer-readable medium of claim 10, wherein mapping the selected fields from the project data from the first format to the second format comprises mapping the project data to a cross tabular format.

13. The computer-readable medium of claim 10, wherein the graphical object is selected from one of: a chart and a table.

14. The computer-readable medium of claim 11, wherein the GUI displays the selected fields from the project data for review.

15. The computer-readable medium of claim 11, wherein the GUI comprises filtering options and sorting options that act on the project data.

16. The computer-readable medium of claim 10, further comprising storing a definition of the selections such that the definition is usable within a different project.

17. A system for creating a dynamic report using project data, comprising:
a processor and a computer-readable medium;
an operating environment stored on the computer-readable medium and executing on the processor; and
a manager operating under the control of the operating environment and operative to actions comprising:
determining a graphical object from at least a chart and a table to display using project data;
accessing the project data using a project management application that is stored according to a first format comprising task fields, resource fields and assignment fields;
mapping selected fields from the project data from the first format to a second format that is used by a graphical object when displaying the project data;
using the selected fields as a data source for the graphical object such that when values in the selected fields change a display of the graphical object changes; and
displaying the graphical object using a graphics object engine that supports the project management application and different applications.

18. The system of claim 17, further comprising displaying a Graphical User Interface (GUI) to: select the fields from the project data; display the selected fields from the project data for review; and display filtering options and sorting options that act on the project data when selected.

19. The system of claim 17, wherein mapping the selected fields from the project data from the first format to the second format comprises mapping the project data to a cross tabular format.

20. The system of claim 17, further comprising storing a definition of the selections such that the definition is usable within a different project.
